(19) United States
(12) Patent Application Publication
(10) Pub. No.: US 2008/0242210 A1
(43) Pub. Date: Oct. 2, 2008

(54) Low-Noise Volume Flow Rate Throttling of Fluid-Carrying Pipes

(75) Inventors: Martin Viertel, Hamburg (DE); Klaus Boock, Timmdorf (DE)

Correspondence Address: INGRASSIA FISHER & LORENZ, P.C., 7010 E. COCHISE ROAD, SCOTTSDALE, AZ, 85253, US

(73) Assignee: AIRBUS DEUTSCHLAND GMBH, Hamburg (DE)

(21) Appl. No.: 12/067,979

(22) PCT Filed: Sep. 27, 2006
(86) PCT No.: PCT/EP2006/009400

§ 371 Date: Mar. 25, 2008

Related U.S. Application Data
(60) Provisional application No. 60/722,024, filed on Sep. 29, 2005.

(30) Foreign Application Priority Data
Sep. 29, 2005 (DE) 10 2005 046 728.8

(51) Int. Cl. B64D 13/00; F16L 55/027

(52) U.S. Cl. 454/76; 138/41

(57) ABSTRACT

The present invention relates to a fluid throttle screen for low-noise control of a fluid volume flow rate (Q) in a pipe and the use of such a throttle screen in an aircraft climate control system. In addition, the present invention relates to a climate control system in an aircraft in whose pipe system at least one such throttle screen is installed. The throttle screen according to the present invention comprises multiple friction elements extending longitudinally in the flow direction, which are situated at a distance to one another in such a way that a fluid is throttled continuously over the extension of the fluid throttle screen as a result of friction on the individual friction elements.

### REFERENCE TO RELATED APPLICATIONS

This application is a U.S. National-Stage entry under 35 U.S.C. § 371 based on International Application No. PCT/EP2006/009400, filed 27 Sept. 2006, which was published under PCT Article 21(2) and claims the benefit of the filing date of German Patent Application No 10 2005 046 728.8 filed 29 Sept. 2005 and of U.S. Provisional Patent Application No. 60/722,024 filed 29 Sept. 2005, the disclosure of which applications is hereby incorporated herein by reference.

### TECHNICAL FIELD

The present invention relates in general to the technical area of fluid mechanics and acoustics. In particular, the present invention relates to a fluid throttle screen, with which the volume flow rate in a fluid-carrying pipe may be reduced with low noise. Furthermore, the present invention relates to the use of such a throttle screen in an aircraft climate control system and a climate control system for an aircraft in which at least one fluid-carrying pipe branch is equipped with an above-mentioned throttle screen for volume flow control.

### BACKGROUND OF THE INVENTION

Climate control systems, particularly those which are used in aircraft, frequently comprise a strongly branched pipe system having a large number of pipe branches to supply the passenger cabin with air-conditioned fresh air. In order to be able to supply different passenger areas intentionally with different quantities of fresh air or in order to ensure that even those passenger areas which are very far from the climate control system are still supplied with sufficient fresh air, throttle screens are typically installed in the pipe branches depending on the passenger area and distance from the climate control system in order to be able to control the fluid volume flow rate in the individual pipe branches in a targeted way.

It would, of course, also be possible to dimension the individual pipe branches using different diameters to control the volume flow rate amount in the particular pipe branches, but this represents a significant effort in technical implementation, which may be avoided easily with the aid of the above-mentioned throttle screens. Notwithstanding this, the pipeline systems must typically be dimensioned newly and separately in each case for different airlines, since most airlines have different requirements for the fresh air supply of different passenger areas, such as the first and second classes. This is made even more difficult because even in identical aircraft types, the different passenger classes are of different sizes for different airlines, which in turn results in the pipeline systems having to be dimensioned separately.

In order to avoid this dimensioning effort in pipeline systems for aircraft climate control systems, a standard pipeline system is typically pre-dimensioned for every aircraft type, which may then be tailored in the individual case to the particular needs using the above-mentioned throttle screens. Screens of this type are typically implemented as single- hole or multihole screens, by which a pressure reduction may be achieved over the throttle screen in the flow direction, by which the fluid volume flow rate may be throttled in the downstream pipe section. The known throttle screens have been shown to be problematic, however, because a broadband noise level results due to the pressure reduction and the inflow turbulence, which is caused by the frequently strong swirl formation behind the screen, as is shown in FIG. 1.

### SUMMARY OF THE INVENTION

Preceding from the problems connected with the known throttle screens, an object of the present invention is to specify a throttle screen for controlling a fluid volume flow rate which generates a lower noise level than the known single-hole or multihole screens as a fluid flows through it.

This object is achieved according to a first aspect of the present invention by a fluid throttle screen, which is adapted to control a fluid volume flow rate in a pipe and which has a plurality of friction elements extending longitudinally in a flow direction of the pipe. For this purpose, the individual friction elements of the plurality of friction elements are situated at a distance to one another in such a way that a fluid flowing against the fluid throttle screen is throttled continuously in its volume flow rate over the extension of the fluid throttle screen in the flow direction as a result of friction on the individual friction elements of the plurality of friction elements. In contrast to the known single-hole or multihole screens, the throttling does not occur punctually and abruptly at the screen here; rather, the inflow pressure of the fluid is throttled continuously and successively over the longitudinal extension of the fluid throttle screen according to the present invention, because of which there is no abrupt pressure drop nor the swirl formations accompanying it, which are responsible for the occurrence of a broadband noise level. The pressure reduction in the fluid throttle screen according to an exemplary embodiment of the present invention occurs via wall friction on the individual friction elements, so that through targeted dimensioning and implementation of the surface composition of the friction elements, undesired noise development may be avoided as much as possible.

In addition, the friction elements may be provided with holes which cause noise damping because of resonator effects, so that the fluid throttle screen additionally acts as a noise damper, which reduces the noise produced by the screen itself even further and, in addition, damps the noise occurring at other points of the climate control system, which is transmitted by the pipe in which the throttle screen is installed. The frequency range in which this damper effect is a maximum may be tailored to the requirements of the individual case by the hole geometry and the degree of perforation.

In order that no flow discontinuities are generated in the area of the fluid throttle screen, it is suggested that the individual friction elements of the plurality of friction elements be situated at least partially equidistant to one another over the extension of the fluid throttle screen in the flow direction.

To avoid possible discontinuities in the throttle screen according to the present invention, at which noises may occur due to flow swirls, the individual friction elements of the plurality of friction elements may be implemented as planar layered bodies, which are situated in relation to the pipe in such a way that the surface normals of the layered bodies extend orthogonally to the flow direction of the pipe. Alternatively, it would also be possible, for example, to implement the respective friction elements of the plurality of friction elements as pipes which are interleaved in one another and concentric to one another, so that their focal point center lines are each coincident and run in the flow direction.

According to a further exemplary embodiment of the fluid throttle screen according to the present invention, the individual friction elements of the plurality of friction elements may be arranged or adapted as layered bodies as explained above, the individual layered bodies being situated in relation to one another in such a way that they mutually intersect in multiple intersection lines, however, which extend in the flow direction of the pipe, so that a honeycomb-like structure which may have flow through it results in the flow direction. In this way, multiple small flow channels are provided, which may contribute especially effectively to the pressure reduction over the fluid throttle screen.

As already explained above, the noise development in specific frequency ranges may be influenced actively through a special implementation of the surface composition of the individual friction elements. Thus, it has been shown through experiments that an effective pressure reduction over the fluid throttle screen may be achieved while simultaneously avoiding noise development if the individual friction elements of the plurality of friction elements are implemented having a surface roughness whose R_{z}. value is in the range between approximately 0.1 mm and 1.0 mm. With correspondingly large volume flow rate quantities, of course, it is also possible to exceed or fall below these values in specific boundaries, however.

According to a further aspect of the present invention, it is suggested that the individual friction elements of the plurality of friction elements be implemented as heating and/or cooling elements, so that a fluid flowing through the fluid throttle screen may be temperature controlled, i.e., either heated or cooled, using the friction elements. Temperature control of this type is necessary for the crew rest compartments in particular, which have their temperature controlled differently than the remaining cabin areas.

According to a further aspect of the present invention, it is suggested that a throttle screen having at least some of the features as described above be used in a climate control system of an aircraft which comprises multiple pipe branches in order to control the fluid volume flow rate in at least one pipe branch. Through the use of the throttle screens according to the present invention in the climate control system of an aircraft, the typically resulting noise level may be reduced as much as possible and, in addition, by using the throttle screens according to the present invention, the air flowing out at an air outlet may be temperature-controlled entirely individually by an aircraft passenger.

Finally, according to a further aspect of the present invention, a climate control system is suggested which comprises multiple pipe branches, at least one throttle screen as described above being installed in at least one pipe branch to control a fluid volume flow rate.

### BRIEF DESCRIPTION OF THE DRAWINGS

In the following, the present invention is explained in greater detail with reference to the attached drawing. The figures illustrating the present invention solely represent an embodiment of the present invention as an example and are not to be seen as restricting the scope of protection in particular.

FIG. 1 shows a cross-section through a known single-hole screen;

FIG. 2 shows an isometric, partially cutaway illustration of a pipe branch having a fluid throttle screen according to the present invention;

FIG. 3 shows a frontal view according to a further embodiment of a fluid throttle screen, viewed in the flow direction;

FIG. 4 shows a frontal view according to still a further embodiment of a fluid throttle screen, viewed in the flow direction; and

FIG. 5 shows a diagram to illustrate the noise reduction using a fluid throttle screen according to the present invention.

Identical or similar elements are identified using identical or corresponding reference numerals in all figures.

### DESCRIPTION OF EXEMPLARY EMBODIMENTS OF THE PRESENT INVENTION

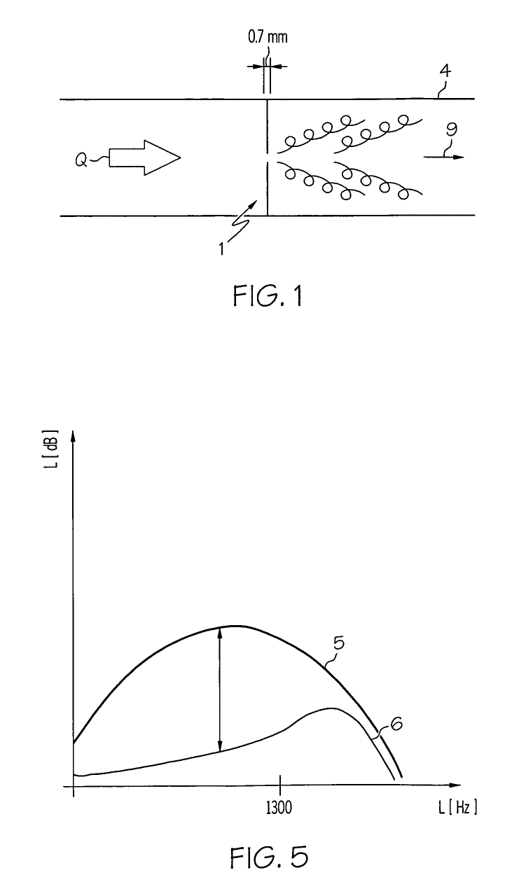

Firstly, a known single-hole screen as has been used until now for volume flow rate throttling in climate control systems will be described briefly with reference to FIG. 1. FIG. 1 shows a pipe branch 4 of a pipe system (not shown further) of a climate control system. A single-hole screen 1 is fitted in the pipe branch 4, which has a fluid flow Q flowing against it from the left. The single-hole screen 1 reduces the inflow Q in its quantity so that a reduced volume flow rate q flows after the single-hole throttle screen 1. Known single-hole throttle screens of this type have a very low thickness in the magnitude of 0.7 mm, which results in the volume flow rate being throttled down suddenly as a result of a very abrupt pressure drop, which causes a relatively strong swirl formation behind the single-hole screen 1. These swirls frequently result in a very strong noise development, which is to be avoided as much as possible, however.

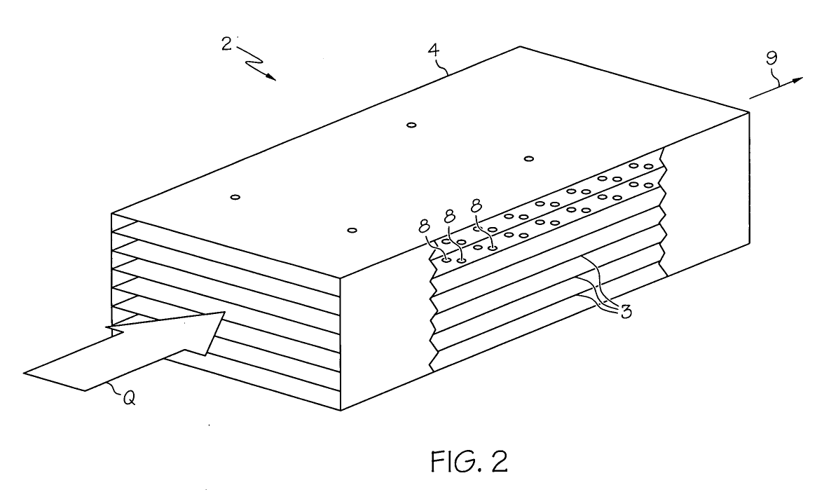

In order to prevent noise development of this type as a result of the sudden pressure drop at the screen, the present invention suggests a fluid throttle screen as is shown as an example in FIG. 2. The fluid throttle screen 2 essentially comprises multiple friction elements 3, which are situated in the interior of a pipe 4. The individual friction elements 3 are situated at a distance to one another in the pipe 4 so that the volume flow rate of a fluid Q flowing against the fluid throttle screen 2 is reduced continuously to a throttled fluid volume flow rate q over the extension of the fluid throttle screen 2 in the flow direction as a result of friction on the individual friction elements 3.

As FIG. 2 also shows, the individual friction elements 3 may be penetrated by multiple holes 8, as is shown for exemplary purposes on the two upper friction elements 3 of the fluid throttle screen 2 according to the present invention. In this way, sound damping of noise, which is generated at another point of the climate control system in which the fluid throttle screen 2 is installed and which propagates through the pipeline system of the climate control system up to the fluid throttle screen 2, may additionally be produced.

The individual friction elements 3 are situated equidistantly and at a distance to one another. In order to avoid dirt adhesion between the individual friction elements 3, the intervals between the individual friction elements 3 are not to be dimensioned significantly less than 5 mm. In contrast to the single-hole screen describing FIG. 1, the fluid throttle screen 2 according to the present invention extends in the flow direction over a longer section, so that the volume flow rate Q may be reduced continuously as a result of friction on the individual friction elements. Experiments have shown that good results may already be achieved using fluid throttle screens 2 whose longitudinal extension in the flow direction is approximately 10 cm. With corresponding boundary conditions, however, it is also possible to give the fluid throttle screen 2 dimensions of multiple decimeters, up to 50 cm or more. In order to effectively avoid noise development, it has also been shown through experiments that the longitudinal extension of the fluid throttle screen according to the present invention is not to be selected as smaller than the smallest clearance of a pipe 4 having fluid flowing through it.

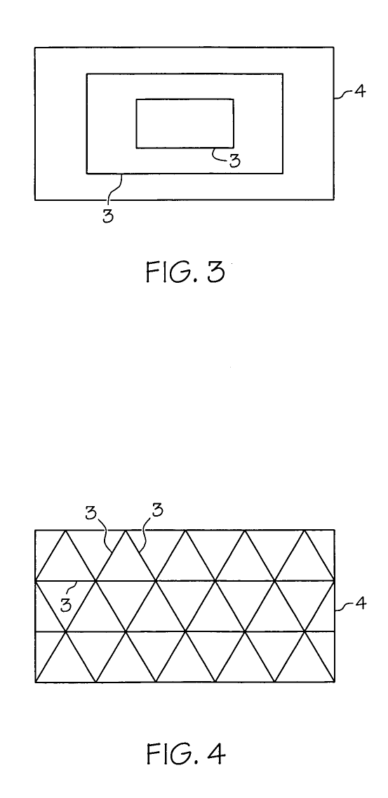

Alternatively to the arrangement of the friction elements 2 shown in FIG. 2, these may also be implemented as (rectangular) pipes interleaved in one another, as shown in FIG. 3. The individual friction elements 3 implemented as pipes are each situated concentrically to one another and also in relation to the pipe having fluid flowing through it, so that the particular focal point center lines are each coincident in the flow direction.

A further alternative of a conceivable arrangement of the friction elements 3 is shown in FIG. 4, in which the friction elements 3 are situated transversely to one another in such a way that they intersect in multiple intersection lines in the flow direction, which also extend in the flow direction, so that a honeycomb-like structure in the form of triangular pipe bodies results viewed in the flow direction. Of course, the friction elements 3 may also form rectangular or hexagonal pipe bodies.

The friction elements 3 may be manufactured from nearly any material, but it is suggested that the friction elements 3 be manufactured from fiberglass-reinforced plastic (GRP) or carbon-fiber-reinforced plastic (CFRP). The desired surface roughnesses of the friction elements 3 may be artificially generated in the range between 0.1 mm and 1.0 mm especially easily in this way.

Finally, the noise reduction achievable using the fluid throttle screen 2 according to the present invention in relation to a typical single-hole throttle screen 1 is explained graphically with reference to FIG. 5. The curve 5 illustrates the frequency-dependent noise development L of a typical single-hole throttle screen. In contrast to this, the curve 6 illustrates the frequency-dependent noise development of a fluid throttle screen according to the present invention. The noise development which is generated by the fluid throttle screen according to the present invention also rises in the high-frequency range from approximately 1300 Hz, but it never reaches the noise level which is generated by a known single-hole throttle screen 1. The fluid throttle screen according to the present invention has been shown to be especially effective, however, in the low-frequency range up to approximately 1300 Hz, in which a maximum noise reduction of up to approximately 15 dB may be achieved.

If the friction elements are additionally also provided with the holes described above and the effective frequency range is tailored to the high frequency range, higher damping may also be achieved, so that over all a frequency response may be achieved as indicated in FIG. 5 in the form of FIG. 7.

In addition it should be pointed out that “comprising” does not exclude other elements or steps, and “a” or “one” does not exclude a plural number. Furthermore, it should be pointed out that features or steps which have been described with reference to one of the above exemplary embodiments can also be used in combination with other features or steps of other exemplary embodiments described above. Reference characters in the claims are not to be interpreted as limitations.

1. A fluid throttle screen for controlling a fluid volume flow rate in a pipe having a plurality of flat friction elements extending in a flow direction of the pipe, wherein the individual friction elements of the plurality of friction elements are arranged at a distance and parallel to one another such that a fluid flowing against the fluid throttle screen has its volume flow rate (Q) continuously throttled over the extension of the fluid throttle screen in the flow direction as a result of friction on the individual friction elements of the multiple friction elements, wherein the individual friction elements of the plurality of friction elements are arranged to control the temperature of a fluid flowing through the fluid throttle screen.

2. The fluid throttle screen of claim 1, wherein individual friction elements of the plurality of friction elements are penetrated by a plurality of holes.

3. The fluid throttle screen of claim 1, wherein the individual friction elements of the plurality of friction elements are arranged at least partially equidistant to one another over the extension of the fluid throttle screen in the flow direction.

4. The fluid throttle screen of one of claim 1 wherein the individual friction elements of the multiple friction elements are arranged as planar layered bodies, whose surface normals extend orthogonally to the flow direction of the pipe.

5. The fluid throttle screen of one of claim 1, wherein the individual friction elements of the plurality of friction elements are arranged as interleaved pipes, whose focal point center lines are each coincident and run in the flow direction.

6. The fluid throttle screen of one of claim 1, wherein the individual friction elements of the plurality of friction elements are arranged as planar layered bodies, which are situated in relation to one another in such a way that they mutually intersect in multiple intersection lines, which extend in the flow direction, so that a honeycomb-like structure results in the flow direction.

7. The fluid throttle screen of claim 1, wherein the individual friction elements of the plurality of friction elements have a surface roughness whose Rz value is approximately in the range between 0.1 mm and 1.0 mm.

8. (canceled)

9. A use of a fluid throttle screen in a climate control system of an aircraft, which comprises multiple pipe branches, for controlling the fluid volume flow rate (Q) in at least one pipe branch, said fluid throttle screen comprising a plurality of flat friction elements extending in a flow direction of the pipe, wherein the individual friction elements of the plurality of friction elements are arranged at a distance and parallel to one another such that a fluid flowing against the fluid throttle screen has its volume flow rate (Q) continuously throttled over the extension of the fluid throttle screen in the flow direction as a result of friction on the individual friction elements of the multiple friction elements, wherein the individual friction elements of the plurality of friction elements are arranged to control the temperature of a fluid flowing through the fluid throttle screen.

10. A climate control system in an aircraft having an air distribution system comprising multiple pipe branches, wherein at least one fluid throttle screen is installed in a pipe branch to control a fluid volume flow rate (Q), said fluid throttle screen comprising a plurality of flat friction elements extending in a flow direction of the pipe, wherein the individual friction elements of the plurality of friction elements are arranged at a distance and parallel to one another such that a fluid flowing against the fluid throttle screen has its volume flow rate (Q) continuously throttled over the extension of the fluid throttle screen in the flow direction as a result of friction on the individual friction elements of the multiple friction elements, wherein the individual friction elements of the plurality of friction elements are arranged to control the temperature of a fluid flowing through the fluid throttle screen.
